(19) United States
(12) Patent Application Publication
(10) Pub. No.: US 2010/0284808 A1
(43) Pub. Date: Nov. 11, 2010

(54) WATERWHEEL APPARATUS HAVING SOLAR-PLANETARY TYPE BLADES

(75) Inventor: Chin-Li Pai, Kaohsiung (TW)

Correspondence Address: WPAT, PC;INTELLECTUAL PROPERTY ATTORNEYS, 2030 MAIN STREET, SUITE 1300, IRVINE, CA, 92614, US

(73) Assignee: WAN CHI STEEL INDUSTRIAL CO., LTD., Kaohsiung (TW)

(21) Appl. No.: 12/507,775

(22) Filed: Jul. 22, 2009

(30) Foreign Application Priority Data
May 7, 2009 (TW) 098115187

(51) Int. Cl. F03B 7/00; F03B 3/00

(52) U.S. Cl. 416/98

(57) ABSTRACT

A waterwheel apparatus having solar-planetary type blades and a solar-planetary type blade assembly thereof are provided. The waterwheel apparatus having solar-planetary type blades includes a frame, at least one solar-planetary type blade assembly, and a power unit. The solar-planetary type blade assembly is fixed to the frame. The solar-planetary type blade assembly includes a rotating disk, a central fixed portion, a plurality of blades, and a transmission mechanism. The rotating disk is capable of rotating relative to the central fixed portion. The blades are pivoted to the rotating disk, and capable of rotating relative to the rotating disk. The transmission mechanism is located between the rotating disk and the central fixed portion for transmitting power between the rotating disk and the central fixed portion, so that the blades can spin and also revolve around the central fixed portion. The power unit has an axle center, and the axle center rotates together with the rotating disk. Thus, when the waterwheel apparatus of the present invention is used to generate power, the power generation efficiency is improved; and when the waterwheel apparatus is used to produce a water flow, the water flow is pushed in the same direction in a large amount and at a low speed.

### BACKGROUND OF THE INVENTION

1. Field of the Invention

The present invention relates to a waterwheel apparatus having solar-planetary type blades and a solar-planetary type blade assembly thereof, and more particularly to a waterwheel apparatus having solar-planetary type blades and a solar-planetary type blade assembly thereof in which the blades are rotatable.

2. Description of the Related Art

With the recent needs for energy conservation and environmental protection as well as worldwide emphasis on renewable energy and green energy, clean energy generated by a water power generation system or water power source becomes increasingly important. There are many water sources all over the world, for example, many countries have rivers, irrigation channels, or even sea currents or tidal currents, and are making efforts to use the clean energy produced by water power generation or use water power as a new power source, but the power generation efficiency is restricted by the performance of the waterwheel apparatus.

Currently, large-sized waterwheel apparatus available on the market are generally designed for high-velocity water flows (above 2.75 m/s), for example, ROC (Taiwan) Patent No. 200835852 entitled “Wind or Water Power Generation Device” and ROC (Taiwan) Patent No. 200844325 entitled “Method and Device for Operating Underwater Power Plant”. Generally, only high-velocity water flows are considered worth exploiting, and all conventional waterwheel apparatuses are designed accordingly. Although there are some water flows having a high velocity (above 2.75 m/s) in the world, the number is quite low. Most water flows have a low velocity (in a range of 0.5 m/s to 2 m/s) (for example, ocean currents (or sea currents) at a depth of about 30 m to 50 m) and are inexhaustible, but they are usually neglected due to low exploitability, and no efforts have been made to develop a high-efficiency waterwheel apparatus suitable for low-velocity water flows. As a result, the energy that such water flows may generate remains undeveloped, which is quite a pity in today's world suffering from energy shortage and highlighting clean environment-friendly energy.

FIGS. 1a and 1b show schematic views of a conventional waterwheel apparatus. In FIG. 1a, a lower portion of the waterwheel apparatus is under water, and an upper portion thereof is above water. In FIG. 1b, the entire waterwheel apparatus is under water. The waterwheel apparatus 1 includes a rotating disk 11 and a plurality of blades 12. The blades 12 are fixed to the rotating disk 11.

When the blades 12 are pushed by a water flow 14, the rotating disk 11 is forced to rotate accordingly, thus driving an axle center of a power generator (not shown) to rotate and generate power.

The waterwheel apparatus 1 has the following problems.

1. As can be seen from FIG. 1a, the blades 12 in Area A of the lower part (under water) directly face the water flow 14, and thus bear the maximum thrust. However, as they are fixed to the rotating disk 11, the blades 12 are pushed by the water flow 14 to rotate to Area B (above water). As air resistance is much smaller than water resistance, though the waterwheel apparatus 1 can be used, its actual work is limited to Area A in the lower part.

2. As can be seen from FIG. 1b, if the entire waterwheel apparatus 1 is under water (for example, the apparatus needs to be put in water at about 20 m to 60 m deep when applied for ocean current power generation), the blades 12 in Area C in the lower part directly face the water flow 14, and bear the maximum thrust. However, as they are fixed to the rotating disk 11, it is the back surface of the blades 12 in Area D in the upper part that faces the water flow 14, so the thrust borne by the blades 12 in Area D and the thrust borne by the blades 12 in Area C are in opposite directions, which hinders the rotation of the rotating disk 11. As a result, the efficiency of the waterwheel apparatus 1 is compromised.

Therefore, it is necessary to provide a waterwheel apparatus having solar-planetary type blades and a solar-planetary type blade assembly thereof to solve the above problems.

### SUMMARY OF THE INVENTION

The present invention is directed to a waterwheel apparatus having solar-planetary type blades. The waterwheel apparatus includes a frame, at least one solar-planetary type blade assembly, and a power unit. The solar-planetary type blade assembly is fixed to the frame, and includes a rotating disk, a central fixed portion, a plurality of blades, and a transmission mechanism. The rotating disk is capable of rotating relative to the central fixed portion. The blades are pivoted to the rotating disk, and capable of rotating relative to the rotating disk. The transmission mechanism is located between the rotating disk and the central fixed portion for transmitting power between the rotating disk and the central fixed portion, so that the blades are capable of spinning and also revolving around the central fixed portion. The power unit has an axle center, and the axle center rotates together with the rotating disk. When the apparatus is used to generate power, as its effective work-done area is much larger than the ineffective area, the power generation efficiency is improved. Besides, when the apparatus is used to produce a flowing fluid, as the blades located in the ineffective area are horizontally disposed and nearly exert no backward thrust on the water flow, the water flow is pushed in the same direction in a large amount and at a low speed, thus avoiding causing turbulence.

### BRIEF DESCRIPTION OF THE DRAWINGS

FIG. 1a is a schematic view of a conventional waterwheel apparatus, in which a lower portion of the waterwheel apparatus is under water, and an upper portion thereof is above water;

FIG. 1b is a schematic view of a conventional waterwheel apparatus, in which the entire waterwheel apparatus is under water;

FIG. 2 is a schematic perspective view of a waterwheel apparatus having solar-planetary type blades according to the present invention;

FIG. 3 is a schematic perspective view of the waterwheel apparatus having solar-planetary type blades according to the present invention with a collector mask removed;

FIG. 4 is a schematic perspective assembly view of a solar-planetary type blade assembly according to a first embodiment of the present invention;

FIG. 5a is a schematic exploded perspective view of the solar-planetary type blade assembly according to the first embodiment of the present invention viewed from a first direction;

FIG. 5b is a schematic exploded perspective view of the solar-planetary type blade assembly according to the first embodiment of the present invention viewed from a second direction;

FIG. 6 is a side view of the solar-planetary type blade assembly according to the first embodiment of the present invention;

FIG. 7 is a side view of a solar-planetary type blade assembly according to a second embodiment of the present invention;

FIG. 8 is a schematic view illustrating the operation of the solar-planetary type blade assembly according to the second embodiment of the present invention;

FIG. 9 is a side view of a solar-planetary type blade assembly according to a third embodiment of the present invention;

FIG. 10 is a side view of a solar-planetary type blade assembly according to a fourth embodiment of the present invention;

FIG. 11 is a schematic perspective assembly view of a solar-planetary type blade assembly according to a fifth embodiment of the present invention; and

FIG. 12 is a schematic exploded perspective view of the solar-planetary type blade assembly according to the fifth embodiment of the present invention.

### DETAILED DESCRIPTION OF THE INVENTION

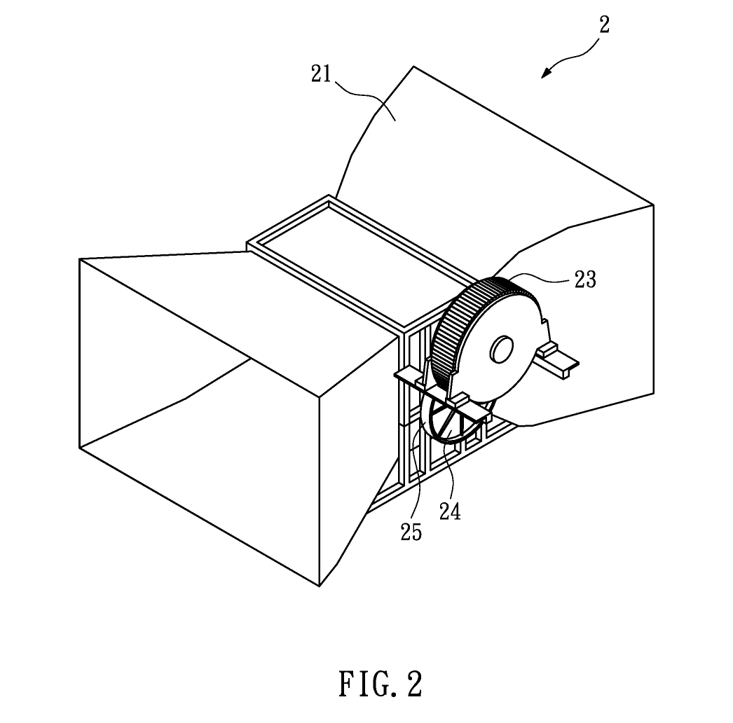

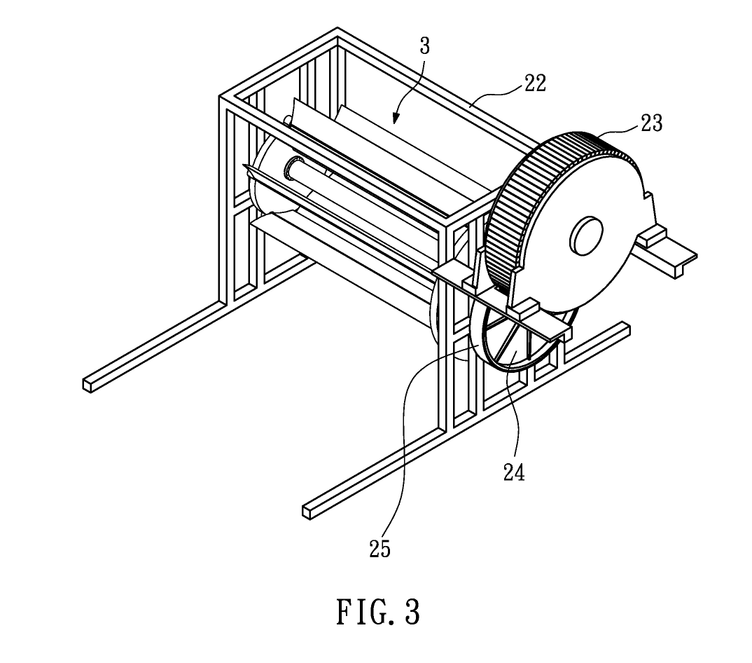

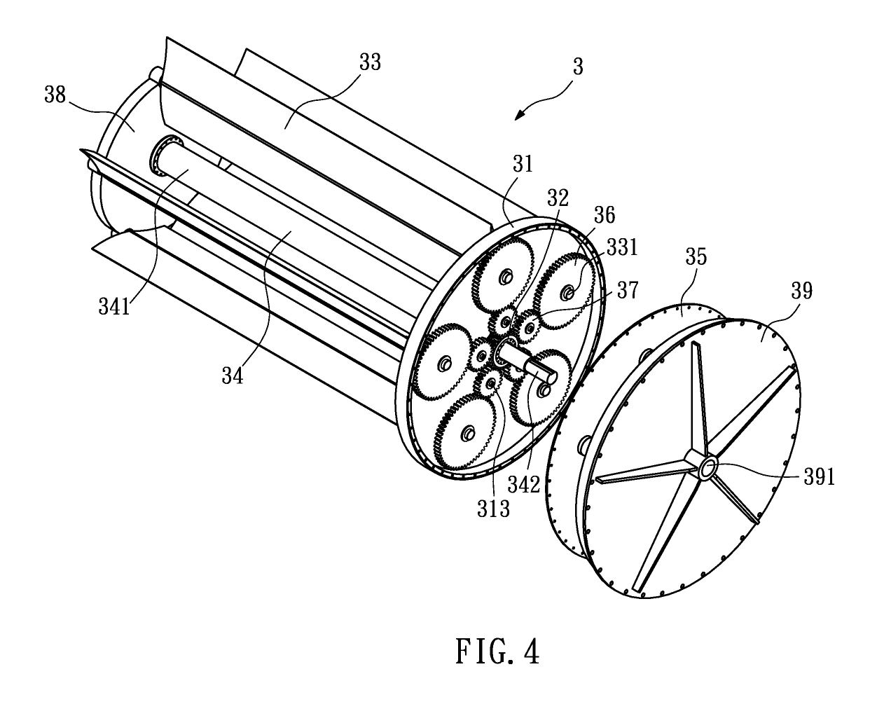

FIG. 2 shows a schematic perspective view of a waterwheel apparatus having solar-planetary type blades according to the present invention. FIG. 3 is a schematic perspective view of the waterwheel apparatus having solar-planetary type blades according to the present invention with a collector mask removed. The entire waterwheel apparatus 2 having solar-planetary type blades can be operated under water. The waterwheel apparatus 2 includes a frame 22, at least one solar-planetary type blade assembly 3, and a power unit 23. The frame 22 is a main support structure. The solar-planetary type blade assembly 3 is fixed to the frame 22. The power unit 23 has an axle center (not shown), and the axle center rotates together with a rotating disk 31 (FIG. 4) of the solar-planetary type blade assembly 3.

In this embodiment, the waterwheel apparatus 2 having solar-planetary type blades further includes a pulley 24 and a belt 25. The rotating disk 31 (FIG. 4) is connected to the pulley 24, and the belt 25 is fitted on the pulley 24 and the axle center of the power unit 23. Thus, the axle center rotates together with the rotating disk 31.

The power unit 23 may be a power generator, a power source (for example, an electric motor), or any other device that can do work. In other words, the applications of the waterwheel apparatus 2 having solar-planetary type blades include, but are not limited to, generating power, producing a flowing water flow, and doing work.

In the first case (generating power), the power unit 23 is a power generator. The solar-planetary type blade assembly 3 is pushed by a water flow, and the rotating disk 31 (FIG. 4) is forced to rotate accordingly, thus driving the axle center of the power generator to rotate and generate power.

In the second case (producing a flowing water flow), the power unit 23 is a power source (for example, an electric motor). The power source is used to drive the rotating disk 31 (FIG. 4), and the solar-planetary type blade assembly 3 is forced to rotate accordingly, thus producing a flowing water flow.

In the third case (doing work), the power unit 23 is a device that can do work. The solar-planetary type blade assembly 3 is pushed by a water flow, and the rotating disk 31 (FIG. 4) is forced to rotate accordingly, thus driving the axle center of the power unit 23 to rotate and do work, for example, milling flour.

Preferably, the waterwheel apparatus 2 having solar-planetary type blades further includes a collector mask 21 placed on the solar-planetary type blade assembly 3, for guiding the direction and increasing the velocity and pressure of the water flow, so that the water flow can generate or exert a great power.

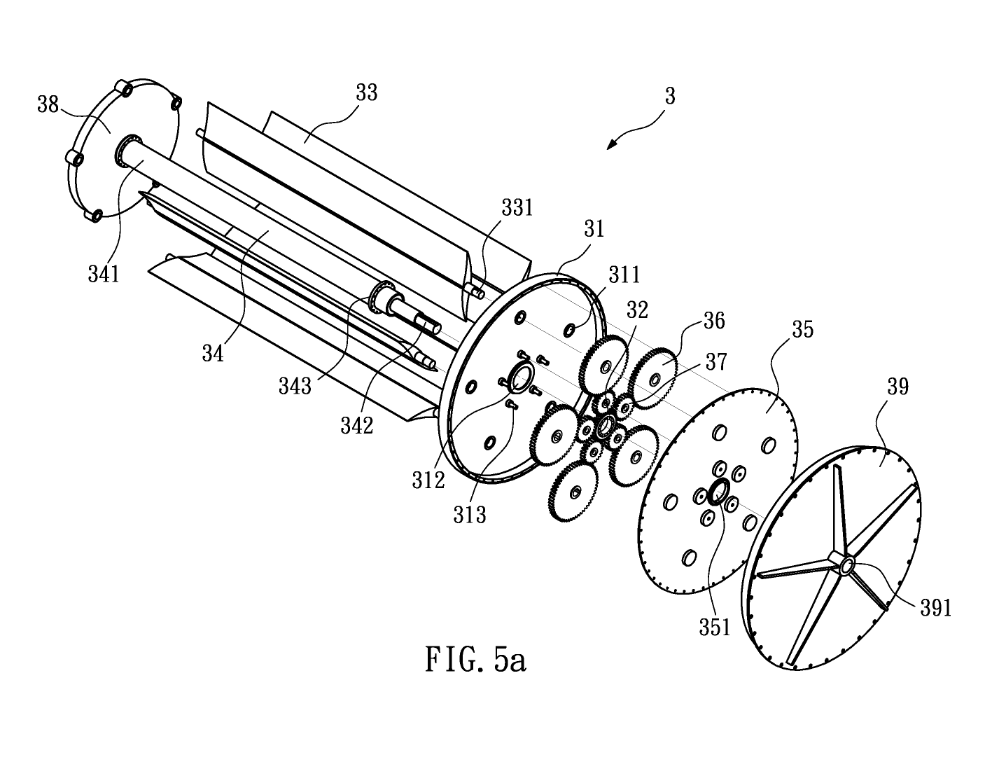

FIG. 4 shows a schematic perspective assembly view of a solar-planetary type blade assembly according to a first embodiment of the present invention. FIGS. 5a and 5b show schematic exploded perspective views of the solar-planetary type blade assembly viewed at different viewing angles according to the first embodiment of the present invention. The solar-planetary type blade assembly 3 includes a rotating disk 31, a central fixed portion 32, a plurality of blades 33, and a transmission mechanism. The central fixed portion 32 is fixed and cannot move. The rotating disk 31 is capable of rotating relative to the central fixed portion 32. The blades 33 are pivoted to the rotating disk 31, and capable of rotating relative to the rotating disk 31. The transmission mechanism is located between the rotating disk 31 and the central fixed portion 32 for transmitting power between the rotating disk 31 and the central fixed portion 32, so that the blades 33 can spin and also revolve around the central fixed portion 32, thus forming a relation like that between the sun and the planets.

The rotating disk 31 is a round disk, and the blades 33 are uniformly distributed at the periphery of the rotating disk 31. Moreover, the rotating disk 31 and the central fixed portion 32 are coaxial, and the axis of each blade 33 is parallel to that of the central fixed portion 32.

Preferably, the solar-planetary type blade assembly 3 further includes a fixed member 39, a protecting disk 35, and a central shaft 34. The fixed member 39 is in the shape of a round disk and fixed to the frame 22 (FIG. 3). The fixed member 39 has a central hole 391 and a flange 392. The protecting disk 35 has a central hole 351, a plurality of first joining holes 352, and a plurality of second joining holes 353. The central shaft 34 has a first end 341, a flange 343, and a second end 342. The flange 392 of the fixed member 39 passes through the central hole 351 of the protecting disk 35, so that the central fixed portion 32 is fixed to the flange 392 of the fixed member 39. The protecting disk 35 covers the rotating disk 31, so as to form an accommodating space to accommodate the central fixed portion 32 and the transmission mechanism.

The rotating disk 31 includes a central hole 312, a central flange 314, a plurality of peripheral holes 311, and a plurality of pins 313. The second end 342 of the central shaft 34 passes through the central hole 312 of the rotating disk 31, the central fixed portion 32, the central hole 351 of the protecting disk 35, and the central hole 391 of the fixed member 39, and is fixed to the pulley 24, and the flange 343 of the central shaft 34 is fixed to the central flange 314 of the rotating disk 31, so that the central shaft 34 rotates together with the rotating disk 31. The blades 33 pass through the peripheral holes 311 and are fixed to the transmission mechanism, and the pins 313 are joined to the transmission mechanism.

In this embodiment, the transmission mechanism includes a plurality of spinning gears 36 and a plurality of idler gears 37. The central fixed portion 32 is a central fixed gear. Each of the blades 33 has a central shaft 331. One end of the central shaft 331 of the blade 33 passes through the corresponding peripheral hole 311 of the rotating disk 31 and is fixed to the spinning gear 36, and the corresponding second joining hole 353 of the protecting disk 35 is joined to the central shaft 331. The idle gears 37 are fitted on the pins 313 of the rotating disk 31 and pivoted to the rotating disk 31. The first joining holes 352 of the protecting disk 35 are joined to the pins 313. The spinning gears 36 are engaged with the idle gears 37, and the idle gears 37 are engaged with the central fixed gear.

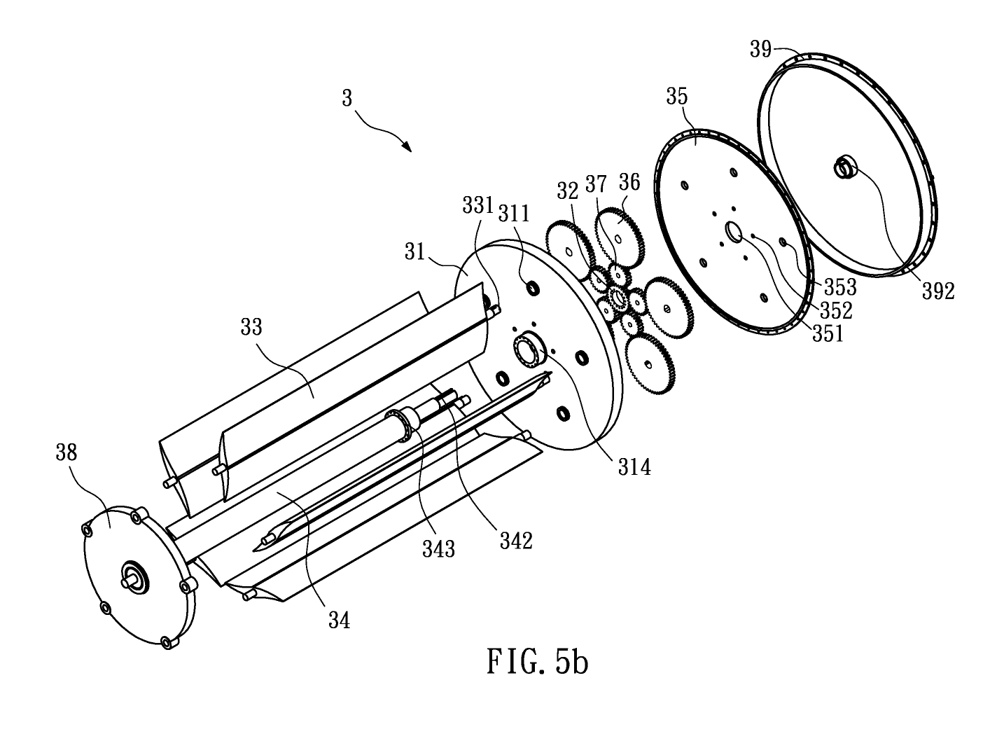

In this embodiment, the number of the blades 33 is five (FIG. 6). However, it is understood that the number of the blades 33 may also be three, four, six, or even more. The surface of each blade 33 may be flat (not shown) or curved.

Preferably, the solar-planetary type blade assembly 3 further includes a driven disk 38. The first end 341 of the central shaft 34 is fixed to the driven disk 38, so that the driven disk 38 rotates together with the rotating disk 31. The other end of each blade 33 is pivoted to the driven disk 38.

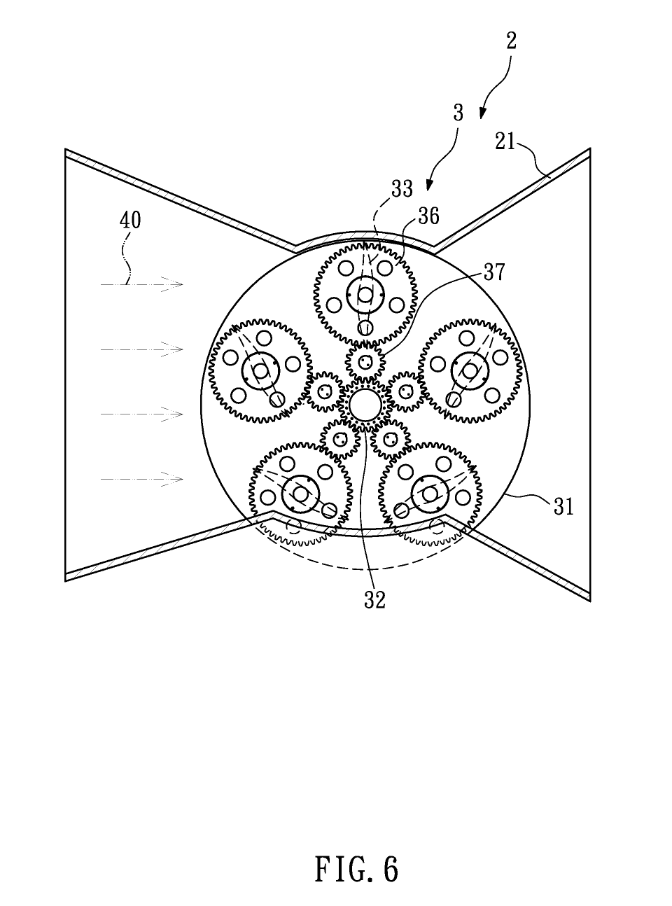

FIG. 7 shows a side view of a solar-planetary type blade assembly according to a second embodiment of the present invention. The solar-planetary type blade assembly 5 of this embodiment is substantially the same as the solar-planetary type blade assembly 3 of the first embodiment (FIGS. 4 to 6), and the same elements are designated with the same reference numerals. The difference between the solar-planetary type blade assembly 5 of this embodiment and the solar-planetary type blade assembly 3 of the first embodiment (FIGS. 4 to 6) lies in the number of the blades 33. In this embodiment, the number of the blades 33 is six.

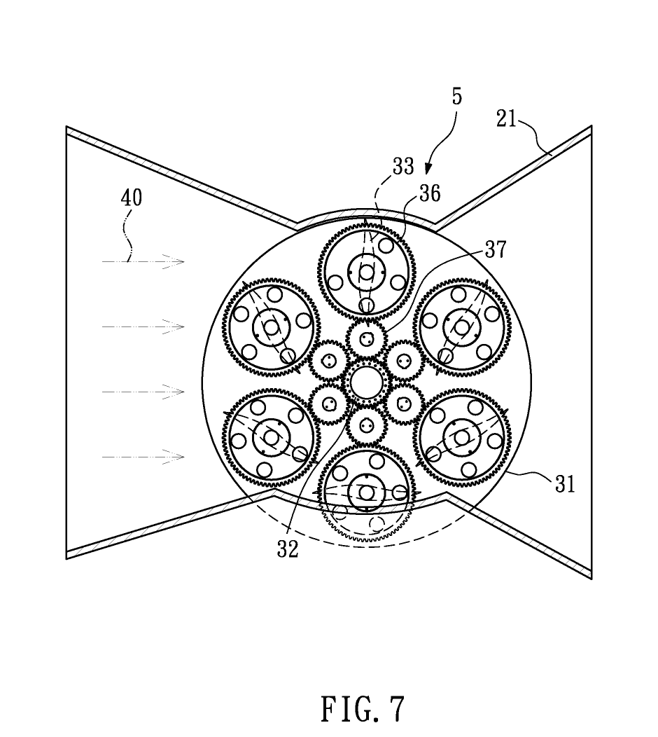

FIG. 8 shows a schematic view illustrating the operation of the solar-planetary type blade assembly according to the second embodiment of the present invention. After a water flow 40 enters the collector mask 21, the blade 33 on the top is perpendicularly disposed, and a front side thereof faces the water flow 40, thus bearing a maximum tangential thrust 41, so as to drive the rotating disk 31 to rotate. The blade 33 gradually moves to the bottom with the rotation of the rotating disk 31, and the tangential thrust 41 borne thereby is gradually reduced. Due to the design of the transmission mechanism in the present invention, the blade 33 not only revolves around the rotating disk 31, but also spins itself to change the angle in contact with the water flow 40. Therefore, the blade 33 on the bottom is horizontally disposed with only one end facing the water flow 40. At this point, the blade 33 bears a rather small tangential thrust, and almost does not hinder the rotation of the rotating disk 31. Afterward, the blade 33 moves to the top with the rotation of the rotating disk 31, and returns to the perpendicular state. During this process, when the blade 33 leaves the bottom position at a certain angle (for example, 5°), it converts the thrust of the water flow 40 into a forward thrust due to its spinning motion. When the blade 33 gradually moves to the perpendicularly position, the tangential thrust 41 borne thereby is also increased accordingly.

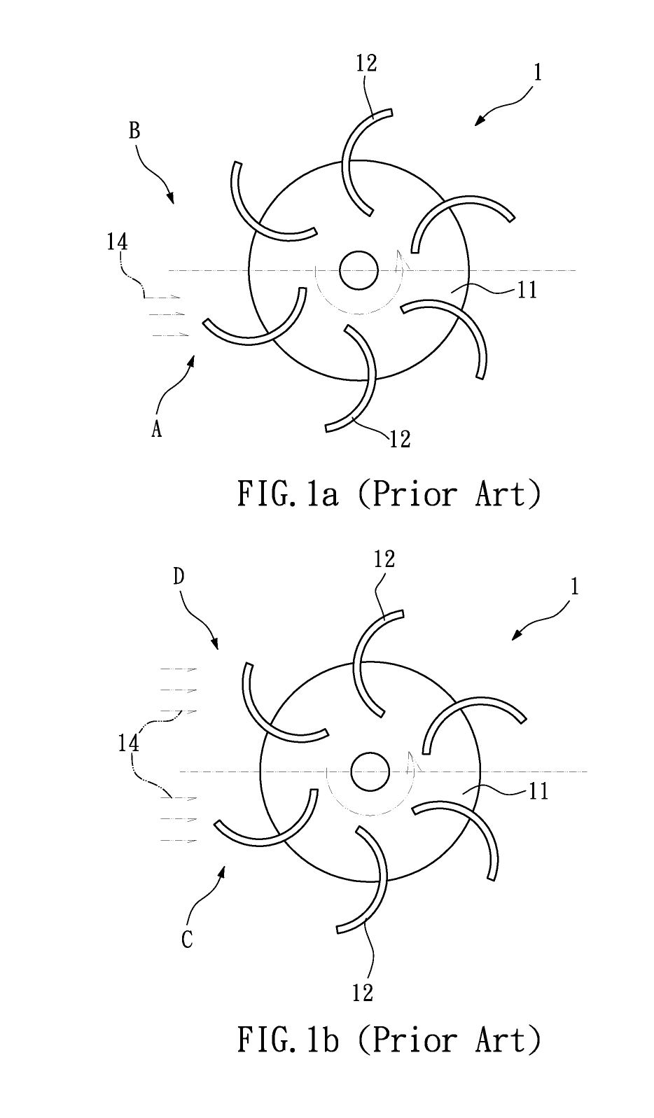

In the present invention, the blade 33 does not bear any tangential thrust at the bottom position (Area F, ineffective area), but bears a tangential thrust at any position above the bottom position (Area E, effective area). As shown in FIG. 8, Area E is much larger than Area F, so the solar-planetary type blade assembly achieves a higher power generation efficiency than the conventional waterwheel apparatus 1 (FIGS. 1a and 1b). Further, in the present invention, as the effective range of Area E is increased, and the water-facing surface of the blade 33 under water in Area F is reduced due to the change of its angle by spinning, the ineffective range of Area F is reduced, thus saving plenty of volume space and reducing the rotating radius of the blade 33. Thus, the rotating speed of the central shaft 34 of the blade 33 is increased. When the present invention is applied to ocean currents of a low velocity, the high rotating speed can enhance the efficiency of the power generator. Further, as the volume space is reduced, the apparatus 2 has a smaller impact on the velocity of the ocean currents, thereby reducing the damage caused by the ocean currents to the natural environment.

In this embodiment, the solar-planetary type blade assembly 5 is horizontally disposed in the water, i.e., the central shaft 34 is parallel to the horizontal plane. However, it is understood that the solar-planetary type blade assembly 5 may also be perpendicularly disposed in the water, i.e., the central shaft 34 is perpendicular to the horizontal plane.

In this embodiment, the power unit 23 (FIGS. 2 and 3) may be a power generator. When the blades 33 are pushed by the water flow 40, the rotating disk 31 and the pulley 24 are forced to rotate accordingly, thus driving the axle center of the power generator to rotate and generate power. The power unit 23 may also be a power source (for example, an electric motor). The power source is used to drive the pulley 24 and the rotating disk 31, so that the blades 33 are forced to rotate accordingly, thus producing a flowing water flow. As the blades 33 in Area F in the lower part are parallel to the water flow, and nearly exert no backward thrust on the water flow, the water flow is pushed in the same direction in a large amount and at a low speed, thus avoiding causing turbulence. The above method may be applied to, for example, water circulation in a culture pond, an electrolytic bath or crystallizer tank, and the like.

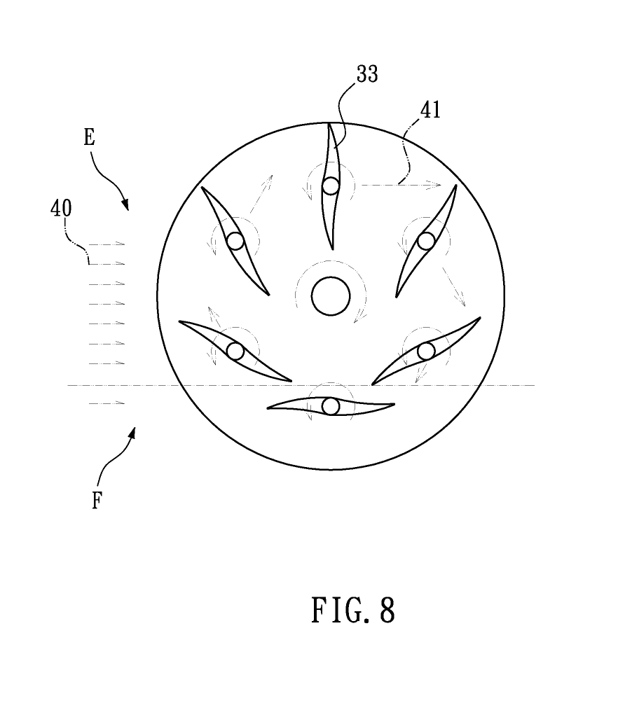

FIG. 9 shows a side view of a solar-planetary type blade assembly according to a third embodiment of the present invention. The solar-planetary type blade assembly 6 of this embodiment is substantially the same as the solar-planetary type blade assembly 5 of the second embodiment (FIG. 7), and the same elements are designated with the same reference numerals. The difference between the solar-planetary type blade assembly 6 of this embodiment and the solar-planetary type blade assembly 5 of the second embodiment (FIG. 7) lies in the transmission mechanism. In this embodiment, the transmission mechanism includes a plurality of spinning sprockets 66, a plurality of idle sprockets 671, and a chain 60. The central fixed portion 62 is a central fixed sprocket. Each of the spinning sprockets 66 is fixed to one end of each blade 33. The idle sprockets 671 are pivoted to a rotating disk 61 and arranged at intervals with the spinning sprockets 66. The chain 60 is wound around the spinning sprockets 66, the idle sprockets 671, and the central fixed portion 62.

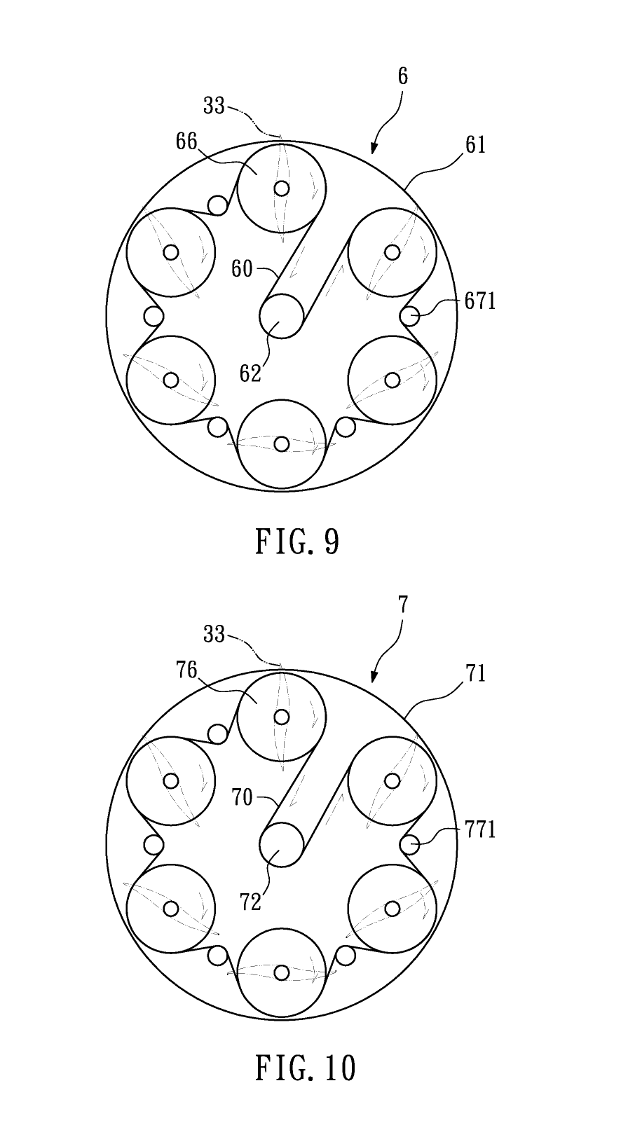

FIG. 10 shows a side view of a solar-planetary type blade assembly according to a fourth embodiment of the present invention. The solar-planetary type blade assembly 7 of this embodiment is substantially the same as the solar-planetary type blade assembly 5 of the second embodiment (FIG. 7), and the same elements are designated with the same reference numerals. The difference between the solar-planetary type blade assembly 7 of this embodiment and the solar-planetary type blade assembly of the second embodiment (FIG. 7) lies in the transmission mechanism. In this embodiment, the transmission mechanism includes a plurality of spinning pulleys 76, a plurality of idle pulleys 771, and a belt 70. The central fixed portion 72 is a central fixed pulley. Each of the spinning pulleys 76 is fixed to one end of each blade 33. The idle pulleys 771 are pivoted to a rotating disk 71 and arranged at intervals with the spinning pulleys 76. The belt 70 is wound around the spinning pulleys 76, the idle pulleys 771, and the central fixed portion 72.

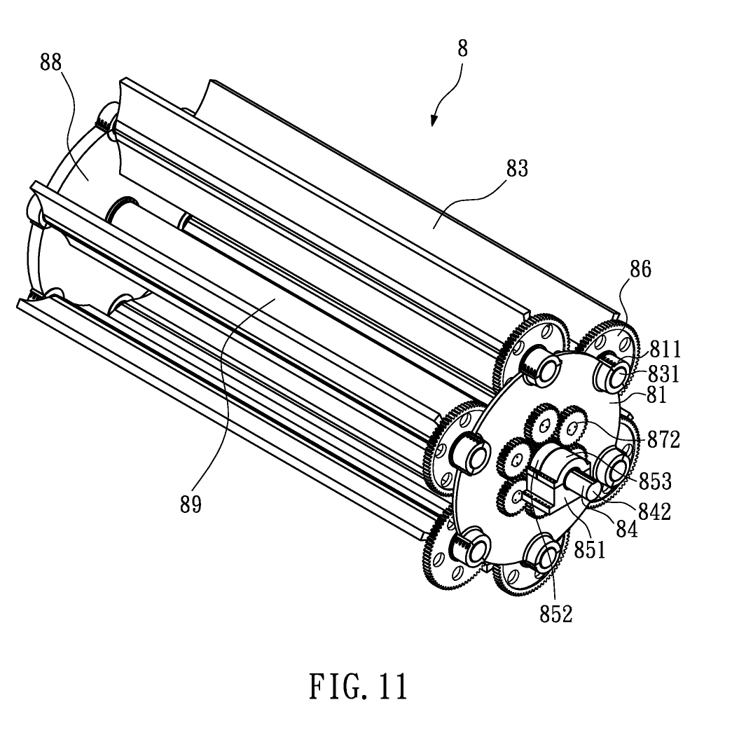

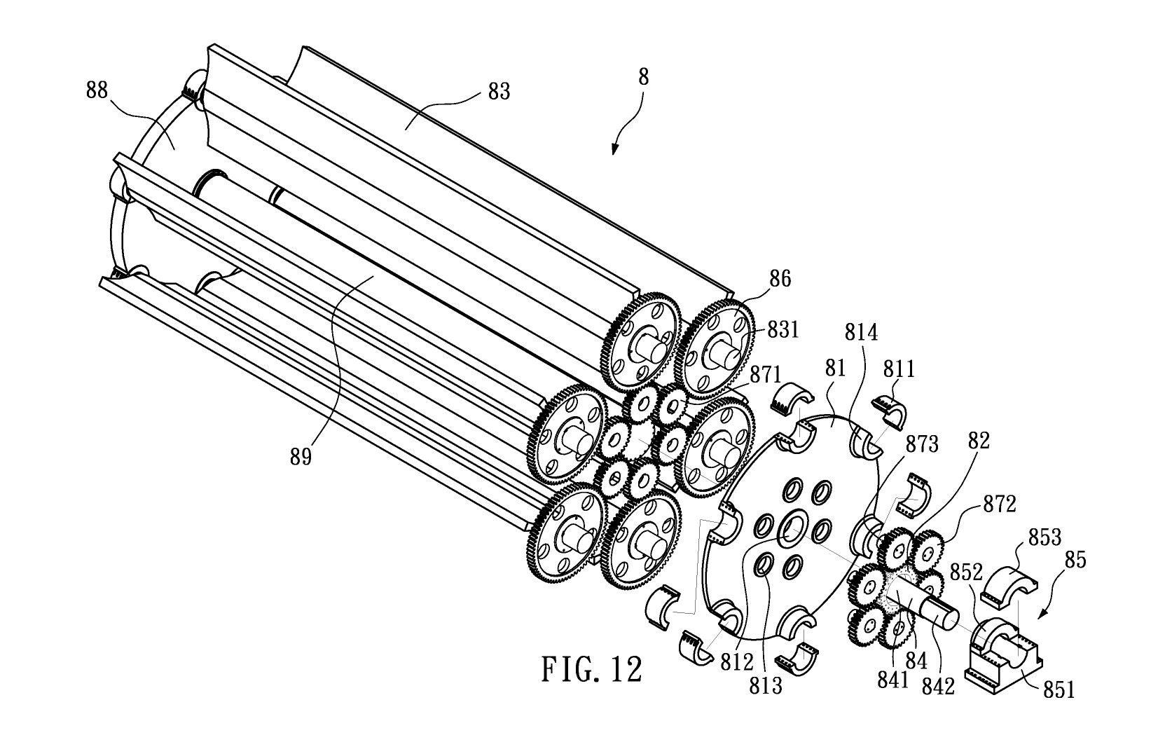

FIGS. 11 and 12 show a schematic perspective assembly view and exploded view, respectively, of a solar-planetary type blade assembly according to a fifth embodiment of the present invention. The solar-planetary type blade assembly 8 includes a rotating disk 81, a central fixed portion 82, a plurality of blades 83, and a transmission mechanism. The central fixed portion 82 is fixed and cannot move. The rotating disk 81 is capable of rotating relative to the central fixed portion 82. The blades 83 are pivoted to the rotating disk 81, and capable of rotating relative to the rotating disk 81. The transmission mechanism is located between the rotating disk 81 and the central fixed portion 82 for transmitting power between the rotating disk 81 and the central fixed portion 82.

The rotating disk 81 is a round disk, and the blades 83 are uniformly distributed at the periphery of the rotating disk 81. Moreover, the rotating disk 81 and the central fixed portion 82 are coaxial.

Preferably, the solar-planetary type blade assembly 8 further includes a fixed mount 85 and a rotating shaft 84. The fixed mount 85 includes a base 851, a first fixed cover 852, and a second fixed cover 853. The fixed mount 85 is fixed to the frame 22 (FIG. 3), and is joined to the rotating shaft 84. The central fixed portion 82 is fixed to the base 851 and the first fixed cover 852. The rotating shaft 84 has a first end 841 and a second end 842. The first end 841 passes through the central fixed portion 82, and is fixed to a central hole 812 of the rotating disk 81. The second end 842 passes through the fixed mount 85, and is fixed to the pulley 24 (FIG. 3).

In this embodiment, the transmission mechanism includes a plurality of connecting shafts 873, a plurality of spinning gears 86, and a plurality of idle gears (i.e., a plurality of first idle gears 871 and a plurality of second idle gears 872), in which the central fixed portion 82 is a central fixed gear. Each of the spinning gears 86 is fixed to one end of each blade 83, and the idle gears 871, 872 are pivoted to the rotating disk 81. The rotating disk 81 has a plurality of holes 813, and the connecting shafts 873 pass through the holes 813 of the rotating disk 81. The two ends of each of the connecting shafts 873 are fixed to the corresponding first idle gear 871 and the second idle gear 872. The spinning gears 86 are engaged with the first idle gears 871, and the second idle gears 872 are engaged with the central fixed gear.

Each of the blades 83 has a central shaft 831. The rotating disk 81 has a plurality of recesses 814 and a plurality of top covers 811. Each of the top covers 811 covers the corresponding recess 814, so as to form an accommodating space to accommodate the central shaft 831 of each blade 83. Preferably, the solar-planetary type blade assembly 8 further includes a driven disk 88 and a driven shaft 89, and the driven shaft 89 is connected to the driven disk 88 and the rotating disk 81, so that the driven disk 88 rotates together with the rotating disk 81. The other end of each blade 83 is pivoted to the driven disk 88.

While several embodiments of the present invention have been illustrated and described, various modifications and improvements can be made by those skilled in the art. The embodiments of the present invention are therefore described in an illustrative but not restrictive sense. It is intended that the present invention should not be limited to the particular forms as illustrated, and that all modifications which maintain the spirit and scope of the present invention are within the scope defined in the appended claims.

What is claimed is:

1. A solar-planetary type blade assembly, comprising:
a rotating disk;
a central fixed portion, wherein the rotating disk is capable of rotating relative to the central fixed portion;
a plurality of blades, pivoted to the rotating disk and being capable of rotating relative to the rotating disk; and
a transmission mechanism, located between the rotating disk and the central fixed portion for transmitting power between the rotating disk and the central fixed portion, so that the blades are capable of spinning and also revolving around the central fixed portion.

2. The solar-planetary type blade assembly according to claim 1, wherein the rotating disk and the central fixed portion are coaxial, and the axis of each blade is parallel to that of the central fixed portion.

3. The solar-planetary type blade assembly according to claim 1, further comprising a fixed member, a protecting disk, and a central shaft, wherein the central fixed portion is fixed to the fixed member, the protecting disk covers the rotating disk so as to form an accommodating space to accommodate the central fixed portion and the transmission mechanism, the central shaft has a first end, a flange, and a second end, the second end passes through the rotating disk, the central fixed portion, the protecting disk, and the fixed member, the flange is fixed to the rotating disk, and the fixed member is joined to the central shaft.

4. The solar-planetary type blade assembly according to claim 3, wherein the rotating disk comprises a central hole, a central flange, a plurality of peripheral holes, and a plurality of pins, the central shaft passes through the central hole, the flange of the central shaft is fixed to the central flange of the rotating disk, the blades respectively passes through the peripheral holes and are fixed to the transmission mechanism, and the pins are joined to the transmission mechanism.

5. The solar-planetary type blade assembly according to claim 1, further comprising a fixed mount and a rotating shaft, wherein the central fixed portion is fixed to the fixed mount, the rotating shaft has a first end and a second end, the first end passes through the central fixed portion and is fixed to the center of the rotating disk, the second end passes through the fixed mount, and the fixed mount is joined to the rotating shaft.

6. The solar-planetary type blade assembly according to claim 1, wherein the transmission mechanism comprises a plurality of spinning gears and a plurality of idle gears, the central fixed portion is a central fixed gear, each of the spinning gears is fixed to one end of each blade, the idle gears are pivoted to the rotating disk, the spinning gears are engaged with the idle gears, and the idle gears are engaged with the central fixed gear.

7. The solar-planetary type blade assembly according to claim 6, further comprising a plurality of connecting shafts, wherein the idle gears comprise a plurality of first idle gears and a plurality of second idle gears, the rotating disk has a plurality of holes, the connecting shafts pass through the holes on the rotating disk, the two ends of each of the connecting shafts are respectively fixed to the corresponding first idle gear and the second idle gear, the spinning gears are engaged with the first idle gears, and the second idle gears are engaged with the central fixed gear.

8. The solar-planetary type blade assembly according to claim 1, wherein the transmission mechanism comprises a plurality of spinning sprockets, a plurality of idle sprockets, and a chain, the central fixed portion is a central fixed sprocket, each of the spinning sprockets is fixed to one end of each blade, the idle sprockets are pivoted to the rotating disk and are arranged at intervals with the spinning sprockets, and the chain is wound around the spinning sprockets, the idle sprockets, and the central fixed portion.

9. The solar-planetary type blade assembly according to claim 1, wherein the transmission mechanism comprises a plurality of spinning pulleys, a plurality of idle pulleys, and a belt, the central fixed portion is a central fixed pulley, each of the spinning pulleys is fixed to one end of each blade, the idle pulleys are pivoted to the rotating disk and arranged at intervals with the spinning pulleys, and the belt is wound around the spinning pulleys, the idle pulleys, and the central fixed portion.

10. The solar-planetary type blade assembly according to claim 1, wherein the number of the blades is three, four, five, or six, and a surface of each blade is flat or curved.

11. The solar-planetary type blade assembly according to claim 1, wherein each of the blades has a central shaft, the rotating disk has a plurality of recesses and a plurality of top covers, and each of the top covers covers the corresponding recess, so as to form an accommodating space to accommodate the central shaft of each blade.

12. The solar-planetary type blade assembly according to claim 1, further comprising a driven disk, wherein the blades are pivoted to the driven disk.

13. The solar-planetary type blade assembly according to claim 1, wherein the blades are pushed by a water flow, so that the rotating disk is forced to rotate accordingly, thus driving an axle center of a power generator to rotate and generate power.

14. The solar-planetary type blade assembly according to claim 1, wherein the blades are pushed by a water flow, so that the rotating disk is forced to rotate accordingly, thus driving an axle center of a power unit to rotate and do work.

15. The solar-planetary type blade assembly according to claim 1, wherein the rotating disk is driven by a power source, so that the blades are forced to rotate accordingly, thus producing a water flow.

16. A waterwheel apparatus having solar-planetary type blades, comprising:
a frame;
at least one solar-planetary type blade assembly, fixed to the frame, and each solar-planetary type blade assembly comprising:
a rotating disk;
a central fixed portion, wherein the rotating disk is capable of rotating relative to the central fixed portion;
a plurality of blades, pivoted to the rotating disk, and being capable of rotating relative to the rotating disk; and
a transmission mechanism, located between the rotating disk and the central fixed portion for transmitting power between the rotating disk and the central fixed portion, so that the blades are capable of spinning and also revolving around the central fixed portion; and
a power unit, having an axle center, wherein the axle center rotates together with the rotating disk.

17. The waterwheel apparatus having solar-planetary type blades according to claim 16, wherein the rotating disk and the central fixed portion are coaxial, and the axis of each blade is parallel to that of the central fixed portion.

18. The waterwheel apparatus having solar-planetary type blades according to claim 16, wherein the solar-planetary type blade assembly further comprises a fixed member, a protecting disk, and a central shaft, the central fixed portion is fixed to the fixed member, the fixed member is fixed to the frame, the protecting disk covers the rotating disk so as to form an accommodating space to accommodate the central fixed portion and the transmission mechanism, the central shaft has a first end, a flange, and a second end, the second end passes through the rotating disk, the central fixed portion, the protecting disk, and the fixed member, the flange is fixed to the rotating disk, and the fixed member is joined to the central shaft.

19. The waterwheel apparatus having solar-planetary type blades according to claim 18, wherein the rotating disk of the solar-planetary type blade assembly comprises a central hole, a central flange, a plurality of peripheral holes, and a plurality of pins, the central shaft passes through the central hole, the flange of the central shaft is fixed to the central flange of the rotating disk, the blades pass through the peripheral holes and are fixed to the transmission mechanism, and the pins are joined to the transmission mechanism.

20. The waterwheel apparatus having solar-planetary type blades according to claim 16, wherein the solar-planetary type blade assembly further comprises a fixed mount and a rotating shaft, the central fixed portion is fixed to the fixed mount, the rotating shaft has a first end and a second end, the first end passes through the central fixed portion and is fixed to the center of the rotating disk, the second end passes through the fixed mount, and the fixed mount is fixed to the frame and further joined to the rotating shaft.

21. The waterwheel apparatus having solar-planetary type blades according to claim 16, wherein the transmission mechanism comprises a plurality of spinning gears and a plurality of idle gears, the central fixed portion is a central fixed gear, each of the spinning gears is fixed to one end of each blade, the idle gears are pivoted to the rotating disk, the spinning gears are respectively engaged with the idle gears, and the idle gears are engaged with the central fixed gear.

22. The waterwheel apparatus having solar-planetary type blades according to claim 21, wherein the solar-planetary type blade assembly further comprises a plurality of connecting shafts, the idle gears comprise a plurality of first idle gears and a plurality of second idle gears, the rotating disk has a plurality of holes, the connecting shafts pass through the holes on the rotating disk, the two ends of each of the connecting shafts are fixed to the corresponding first idle gear and the second idle gear, the spinning gears are engaged with the first idle gears, and the second idle gears are engaged with the central fixed gear.

23. The waterwheel apparatus having solar-planetary type blades according to claim 16, wherein the transmission mechanism comprises a plurality of spinning sprockets, a plurality of idle sprockets, and a chain, the central fixed portion is a central fixed sprocket, each of the spinning sprockets is fixed to one end of each blade, the idle sprockets are pivoted to the rotating disk and arranged at intervals with the spinning sprockets, and the chain is wound around the spinning sprockets, the idle sprockets, and the central fixed portion.

24. The waterwheel apparatus having solar-planetary type blades according to claim 16, wherein the transmission mechanism comprises a plurality of spinning pulleys, a plurality of idle pulleys, and a belt, the central fixed portion is a central fixed pulley, each of the spinning pulleys is fixed to one end of each blade, the idle pulleys are pivoted to the rotating disk and arranged at intervals with the spinning pulleys, and the belt is wound around the spinning pulleys, the idle pulleys, and the central fixed portion.

25. The waterwheel apparatus having solar-planetary type blades according to claim 16, wherein the number of the blades is three, four, five, or six, and a surface of each blade is flat or curved.

26. The waterwheel apparatus having solar-planetary type blades according to claim 16, wherein each of the blades has a central shaft, the rotating disk has a plurality of recesses and a plurality of top covers, and each of the top covers covers the corresponding recess, so as to form an accommodating space to accommodate the central shaft of each blade.

27. The waterwheel apparatus having solar-planetary type blades according to claim 16, wherein the solar-planetary type blade assembly further comprises a driven disk, and the blades are pivoted to the driven disk.

28. The waterwheel apparatus having solar-planetary type blades according to claim 16, wherein the power unit is a power generator, and the blades are pushed by a water flow, so that the rotating disk is forced to rotate accordingly, thus driving the axle center of the power generator to rotate and generate power.

29. The waterwheel apparatus having solar-planetary type blades according to claim 16, wherein the blades are pushed by a water flow, so that the rotating disk is forced to rotate accordingly, thus driving the axle center of the power generator to rotate and do work.

30. The waterwheel apparatus having solar-planetary type blades according to claim 16, wherein the power unit is a power source, and the rotating disk is driven by the power source, so that the blades are forced to rotate accordingly, thus producing a water flow.

31. The waterwheel apparatus having solar-planetary type blades according to claim 16, further comprising a collector mask placed on the solar-planetary type blade assembly for guiding the direction of a water flow.
